(19) United States
(12) Patent Application Publication
(10) Pub. No.: US 2007/0098277 A1
(43) Pub. Date: May 3, 2007

(54) Transmitting apparatus, image processing system, image processing method, program, and recording medium

(76) Inventors: Takashi Watanabe, Osaka (JP); Tsuyoshi Maeda, Hyogo (JP)

Correspondence Address: RATNERPRESTIA, P.O. BOX 980, VALLEY FORGE, PA, 19482, US

(21) Appl. No.: 10/561,252

(22) PCT Filed: Mar. 9, 2004
(86) PCT No.: PCT/JP04/03021

§ 371 Date: Dec. 19, 2005

(51) Int. Cl. G06K 9/36

(52) U.S. Cl. 382/236

(57) ABSTRACT

An apparatus or system transmits a video signal of a screen of a PC or the like to a display such as a projector accurately at a high speed via a network. The apparatus or system includes a region determining unit comparing each block of a predetermined frame of a video signal composed of frames zone-divided into a predetermined number of blocks with each block corresponding to the block within an immediately preceding frame of the predetermined frame, and thereby determining a rectangular region including a region having a different pixel value; an extracting unit extracting a video signal included in (1) the determined rectangular region or (2) a rectangular region obtained from the determined rectangular region by applying a predetermined rule; and a transmitting unit transmitting the video signal extracted by the extracting unit.

### TECHNICAL FIELD

The present invention relates to a transmitting apparatus, an image processing system, an image processing method, a program, and a recording medium for image processing and outputting of a video signal.

### BACKGROUND ART

With the recent spread of PCs, wired/wireless LANs employing the Internet or intranets are spreading, while environment for the these networks are improved. Presentation or the like is performed frequently by displaying the screen images of a PC onto a liquid crystal display projector, a large size display, or the like. Nevertheless, in general, the video signal cable of connecting the PC to the liquid crystal display projector or the like is thick and hence causes inconvenience in its handling. Further, in many cases, such presentation has been performed using a notebook PC carried to the hall where the presentation is performed. Thus, real-time transmission of PC screen images is desired which is achieved by means of wireless/wired LAN communication using a network such as an intranet without the necessity of carrying the PC and reconstructing the environment.

A system of transmitting a screen image of a PC to a liquid crystal display projector by wireless is disclosed in JP-A No. H10-145796. Here, the entire disclosure of JP-A No. H10-145796 is incorporated herein by reference in its entirety. In this system, a video signal from a PC is coded, while the signal is transmitted from a transmitting apparatus. Then, the signal received in a receiving section is decoded, while the decoded video signal is projected from a projector. At that time, frames are compared with each other, so that a portion changed from the preceding frame is solely transmitted.

FIG. 15 is a model diagram showing a problem in the prior art. Numeral 61 indicates a PC (personal computer) having screen data. Numeral 62 indicates the screen data itself of the PC. Numeral 63 indicates a transmission region regarded as a region where a difference value has been detected as a result of the comparison with the preceding frame, so that the entire video signal included in the region is transmitted. The image data in this region is transmitted. Numeral 64 indicates a difference region where a difference value has been detected as a result of the comparison with the preceding frame.

After calculating regions (referred to as difference regions, hereafter) where a difference value from the preceding frame has been detected, a minimum rectangular region that includes all the calculated difference regions 64 is obtained as a transmission region 63. Then, the entire video signal included in this transmission region 63 is transmitted.

Further, FIG. 16 is another example of the screen data 62 of FIG. 15. In FIG. 16, numeral 62a is the screen data itself. Numeral 64a indicates a difference region where a difference value has been detected as a result of the comparison with the preceding frame. Numeral 63aindicates a transmission region regarded as a region where a difference value has been detected as a result of the comparison with the preceding frame, so that the entire video signal included in the region is transmitted.

Regions where a difference value from the preceding frame has been detected, that is, the difference regions 64a, are distributed in a point-like manner as indicated by “x” marks in FIG. 16. However, even in the case of such point-like distribution, each region is referred to as a difference region 64a. In the case of the screen 62a, processing is performed similarly to the case of the screen 62. That is, after calculating the difference regions 64a, a minimum rectangular region that includes all the calculated difference regions 64a is obtained as a transmission region 63a. Then, the entire video signal included in this transmission region 63a is transmitted.

Nevertheless, in this configuration, in the calculation of the difference regions having a pixel value different from the preceding frame, when the coordinates of regions having a pixel changed from the preceding frame are regarded as difference regions, a region between the maximum and the minimum of these coordinates is regarded as the transmission region. At that time, as shown in FIG. 15 or 16, when a plurality of difference regions are present at distant places, a region which is not a difference region, that is, an image (portion) having the same pixels as the preceding frame, is also regarded as the transmission region. For example, in FIG. 15, the transmission region 63 includes a rather large region other than the difference regions 64. This causes a problem that an increase is caused in the amount of image data to be transmitted, and that a load increase is caused in the traffic, so that degradation is caused in the immediacy necessary for real-time transmission.

That is, the prior art system has a problem that an increase is caused in the amount of image data to be transmitted, and that a load increase is caused in the traffic, so that degradation is caused in the immediacy necessary for real-time transmission.

### DISCLOSURE OF THE INVENTION

With considering the above-mentioned problem, an object of the invention is to provide a transmitting apparatus, an image processing system, an image processing method, a program, and a recording medium in which no increase is caused in the amount of image data to be transmitted, and in which no load increase is caused in the traffic so that no degradation is caused in the immediacy necessary for real-time transmission.

In order to solve the above problem, the 1^{st} aspect of the present invention is a transmitting apparatus of outputting a video signal generated by a video signal generating apparatus of generating said video signal constructed with frames, to a receiving apparatus having a receiving unit receiving a transmitted video signal and an output unit outputting said received video signal by means of scanning lines, said apparatus comprising:

a block dividing unit zone-dividing said frame into a predetermined number of blocks in parallel to the scanning lines of said output unit said receiving apparatus;

a region determining unit comparing each block of said predetermined frame generated by said block dividing unit with each block corresponding to the block within an immediately preceding frame of said predetermined frame, and thereby determining a rectangular region having a different pixel value;

an extracting unit extracting a video signal included in (1) the determined rectangular region or (2) a rectangular region obtained from the determined rectangular region by applying a predetermined rule; and

a transmitting unit coding the video signal extracted by said extracting unit and then transmitting the signal to said receiving apparatus.

Furthermore, the 2^{nd} aspect of the present invention is a transmitting apparatus of outputting a video signal generated by a video signal generating apparatus of generating said video signal constructed with even number fields and odd number fields, to a receiving apparatus having a receiving unit receiving a transmitted video signal and an output unit outputting said received video signal by means of scanning lines, said apparatus comprising:

a block dividing unit zone-dividing said even number field or odd number field into a predetermined number of blocks in parallel to the scanning lines of said output unit of said receiving apparatus;

a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value;

an extracting unit extracting a video signal included in (1) the determined rectangular region or (2) a rectangular region obtained from the determined rectangular region by applying a predetermined rule; and

a transmitting unit coding the video signal extracted by said extracting unit and then transmitting the signal to said receiving apparatus.

Furthermore, the 3^{rd} aspect of the present invention is a transmitting apparatus according to the 1^{st} or the 2^{nd} aspect of the present invention, wherein said predetermined rule is that when each of said blocks adjacent in a horizontal or vertical direction has a rectangular region determined by said region determining unit, a rectangular region is generated that includes both of the rectangular regions of said blocks adjacent in a horizontal or vertical direction.

Furthermore, the 4^{th} aspect of the present invention is a transmitting apparatus according to the 3^{rd} aspect of the present invention, wherein said region that includes both of the rectangular regions of said blocks adjacent in a horizontal or vertical direction indicates a minimum rectangular region that includes both of said rectangular regions of said blocks adjacent in a horizontal or vertical direction.

Furthermore, the 5^{th} aspect of the present invention is a transmitting apparatus according to the 1^{st} or the 2^{nd} aspect of the present invention, wherein said predetermined rule is that when each of said blocks adjacent in a horizontal or vertical direction has a rectangular region determined by said region determining unit and when these rectangular regions contact with each other in a horizontal or vertical direction, a rectangular region is generated that includes both of the rectangular regions of said blocks adjacent in a horizontal or vertical direction.

Furthermore, the 6^{th} aspect of the present invention is a transmitting apparatus according to the 5^{th} aspect of the present invention, wherein said rectangular region that includes both of the rectangular regions of said blocks adjacent in a horizontal or vertical direction indicates a minimum rectangular region that includes both of said rectangular regions of said predetermined blocks adjacent in a horizontal or vertical direction.

Furthermore, the 8th aspect of the present invention is a transmitting apparatus according to the 1^{st} or the 2^{nd} aspect of the present invention, wherein said region determining unit determines said rectangular region in parallel to the scanning lines of said output unit of said receiving apparatus.

Furthermore, the 10^{th} aspect of the present invention is a transmitting apparatus according to the 1^{st} or the 2^{nd} aspect of the present invention, wherein:

said transmitting apparatus serves also as said video signal generating apparatus;

said transmitting apparatus and said video signal generating apparatus are a personal computer; and

said receiving apparatus is a liquid crystal display projector, a DLP projector, or a PDP.

Furthermore, the 11^{th} aspect of the present invention is an image processing system comprising:

a receiving apparatus having a receiving unit receiving a transmitted video signal and an output unit outputting said received video signal by means of scanning lines;

a video signal generating apparatus of generating a video signal constructed with frames;

a transmitting apparatus having: a block dividing unit zone-dividing said frame into a predetermined number of blocks in parallel to the scanning lines of said output unit of said receiving apparatus; a region determining unit comparing each block of said predetermined frame generated by said block dividing unit with each block corresponding to the block within an immediately preceding frame of said predetermined frame, and thereby determining a rectangular region having a different pixel value; an extracting unit extracting a video signal included in (1) the determined rectangular region or (2) a rectangular region obtained from the determined rectangular region by applying a predetermined rule; and a transmitting unit coding the video signal extracted by said extracting unit and then transmitting the signal to said receiving apparatus.

Furthermore, the 12^{th} aspect of the present invention is an image processing system comprising:

a receiving apparatus having a receiving unit receiving a transmitted video signal and an output unit outputting said received video signal by means of scanning lines;

a video signal generating apparatus of generating a video signal constructed with even number fields and odd number fields; and

a transmitting apparatus having: a block dividing unit zone-dividing said even number field or odd number field into a predetermined number of blocks in parallel to the scanning lines of said output unit of said receiving apparatus; a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value; an extracting unit extracting a video signal included in (1) the determined rectangular region or (2) a rectangular region obtained from the determined rectangular region by applying a predetermined rule; and a transmitting unit coding the video signal extracted by said extracting unit and then transmitting the signal to said receiving apparatus.

Furthermore, the 15^{th} aspect of the present invention is an image processing system according to the 11^{th} or the 12^{th} aspect of the present invention, wherein:

said transmitting apparatus serves also as said video signal generating apparatus;

said video signal generating apparatus and said transmitting apparatus are a personal computer; and

said receiving apparatus is a liquid crystal display projector, a DLP projector, or a PDP.

Furthermore, the 17^{th} aspect of the present invention is an image processing method of outputting a video signal generated by a video signal generating apparatus of generating said video signal constructed with frames, to a receiving apparatus having a receiving unit receiving a transmitted video signal and an output unit outputting said received video signal by means of scanning lines, said method comprising:

a block dividing step of zone-dividing said frame into a predetermined number of blocks in parallel to the scanning lines of said output unit of said receiving apparatus;

a region determining step of comparing each block of said predetermined frame generated at said block dividing step with each block corresponding to the block within an immediately preceding frame of said predetermined frame, and thereby determining a rectangular region having a different pixel value;

an extracting step of extracting a video signal included in (1) the determined rectangular region or (2) a rectangular region obtained from the determined rectangular region by applying a predetermined rule; and

a transmitting step of coding the video signal extracted at said extracting step and then transmitting the signal to said receiving apparatus.

Furthermore, the 18^{th} aspect of the present invention is an image processing method of outputting a video signal generated by a video signal generating apparatus of generating said video signal constructed with even number fields and odd number fields, to a receiving apparatus having a receiving unit receiving a transmitted video signal and an output unit outputting said received video signal by means of scanning lines, said method comprising:

a block dividing step of zone-dividing said even number field or odd number field into a predetermined number of blocks in parallel to the scanning lines of said output unit of said receiving apparatus;

a region determining step of comparing each block of said even number field or odd number field generated at said block dividing step with each block corresponding to the block within an immediately preceding even number field or odd number field of said predetermined even number field or odd number field, and thereby determining a rectangular region having a different pixel value;

an extracting step of extracting a video signal included in (1) the determined rectangular region or (2) a rectangular region obtained from the determined rectangular region by applying a predetermined rule; and

a transmitting step of coding the video signal extracted at said extracting step and then transmitting the signal to said receiving apparatus.

Furthermore, the 19^{th} aspect of the present invention is a program of causing a computer to serve, in a transmitting apparatus according to the 1^{st} aspect of the present invention, as:

a block dividing unit zone-dividing said frame into a predetermined number of blocks in parallel to the scanning lines of said output unit of said receiving apparatus;

a region determining unit comparing each block of said predetermined frame generated by said block dividing unit with each block corresponding to the block within an immediately preceding frame of said predetermined frame, and thereby determining a rectangular region having a different pixel value;

an extracting unit extracting a video signal included in (1) the determined rectangular region or (2) a rectangular region obtained from the determined rectangular region by applying a predetermined rule; and

a transmitting unit coding and transmitting the video signal extracted by said extracting unit, in accordance with said receiving apparatus.

Furthermore, the 20^{th} aspect of the present invention is a program of causing a computer to serve, in a transmitting apparatus according to the 2^{nd} aspect of the present invention, as:

a block dividing unit zone-dividing said even number field or odd number field into a predetermined number of blocks in parallel to the scanning lines of said output unit of said receiving apparatus;

a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value;

an extracting unit extracting a video signal included in (1) the determined rectangular region or (2) a rectangular region obtained from the determined rectangular region by applying a predetermined rule; and

a transmitting unit coding the video signal extracted by said extracting unit and then transmitting the signal to said receiving apparatus.

Furthermore, the 21^{st} aspect of the present invention is a computer-processible recording medium which carries a program according to the 19^{th} or the 20^{th} aspect of the present invention.

According to the present invention, difference regions present at distant positions can be regarded as independent regions. This provides the effect of reducing the occasion of transmitting a region that is not a difference region.

### BRIEF DESCRIPTION OF THE DRAWINGS

FIG. 1 is a diagram showing a mode of a system according to Embodiments 1 and 2 of the present invention.

FIG. 2 is a flow chart showing a procedure of a technique on an image signal transmitting side according to Embodiment 1 of the present invention.

FIG. 3 is a block diagram showing a configuration of a PC according to Embodiments 1 and 2 of the present invention.

FIG. 4 is a model diagram showing a detection method for a difference region by means of block zone dividing of a screen according to Embodiments 1 and 2 of the present invention.

FIG. 5 is another model diagram showing a detection method for a difference region by means of block zone dividing of a screen according to Embodiments 1 and 2 of the present invention.

FIG. 6 is a flow chart showing a procedure of processing in a projector according to Embodiment 2 of the present invention.

FIG. 7 is a model diagram of a projector of displaying data transferred from a PC via a network according to Embodiment 2 of the present invention.

FIG. 8 is a model diagram of an example of processing in which screen data is zone-divided on a block basis according to Embodiment 2 of the present invention.

FIG. 9 is a model diagram showing a calculation method for a transmission region by means of block zone dividing of a screen according to Embodiment 3 of the present invention.

FIG. 10 is a diagram showing a method of name assignment to each block according to Embodiment 3 of the present invention.

FIG. 11 is a flow chart showing a calculation method for a transmission region by means of block zone dividing according to Embodiment 3 of the present invention.

FIG. 12 is a diagram showing a calculation method for a transmission region by means of block zone dividing according to Embodiment 3 of the present invention.

FIG. 13 is another flow chart showing a calculation method for a transmission region by means of block zone dividing according to Embodiment 3 of the present invention.

Fig. 14 is another diagram showing a calculation method for a transmission region by means of block zone dividing according to Embodiment 3 of the present invention.

FIG. 15 is a model diagram of difference region detection in a prior art system.

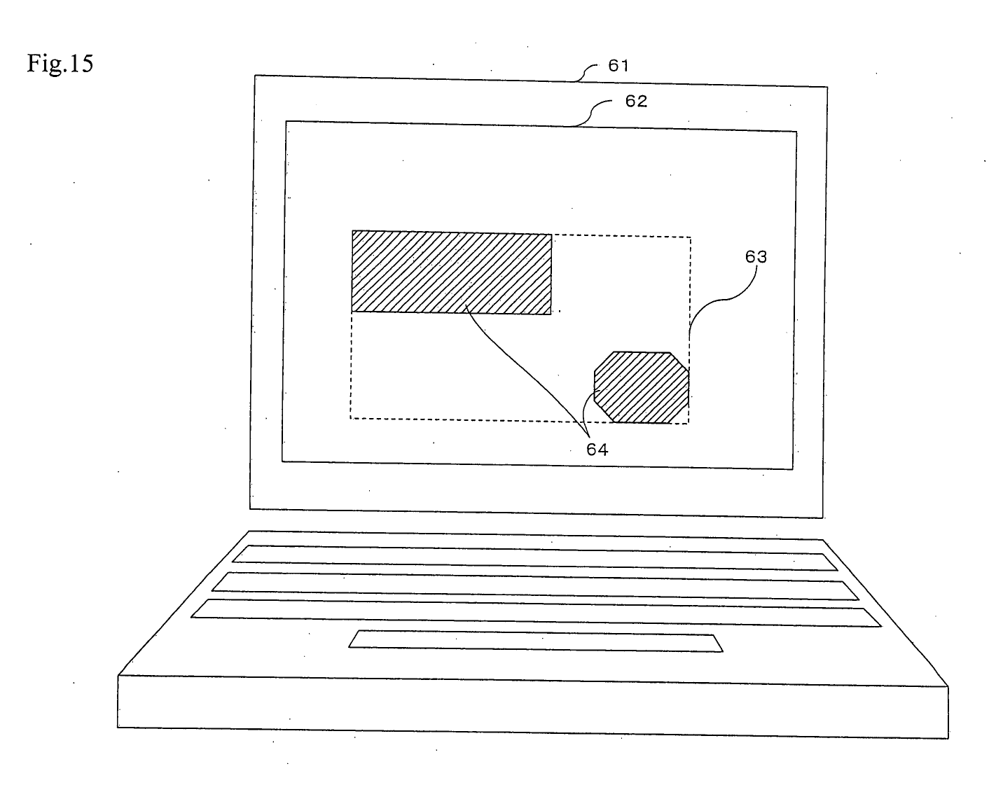

FIG. 16 is a diagram showing another example of screen data in a prior art system.

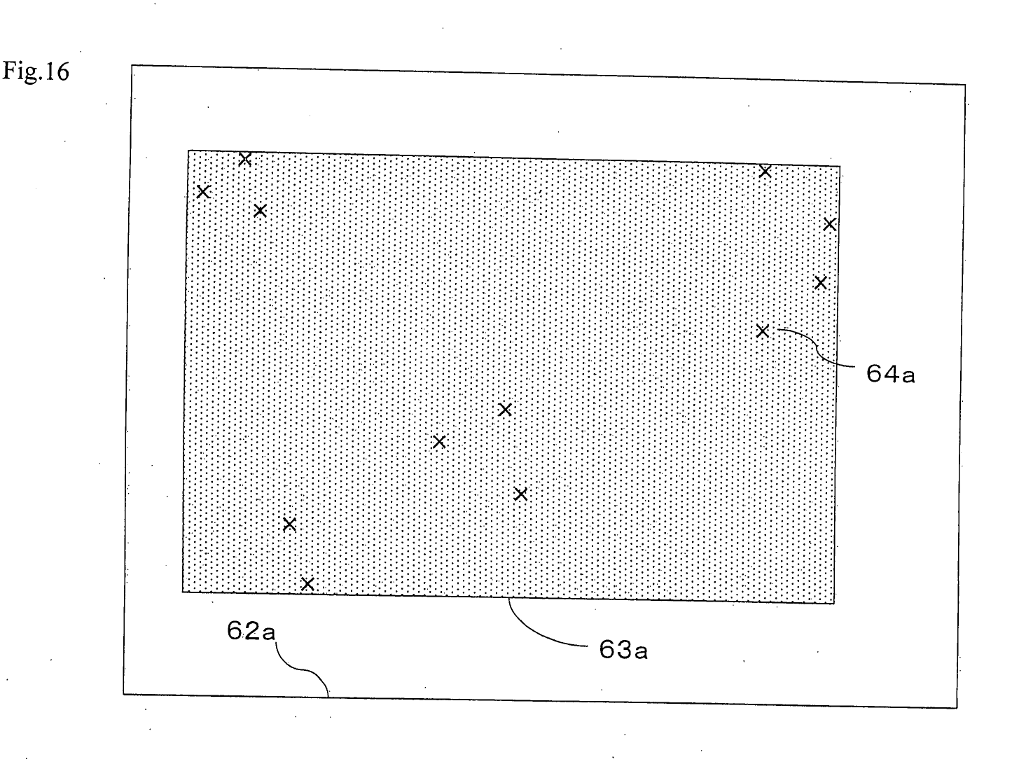

### DESCRIPTION OF REFERENCE NUMERALS

11 Personal computer

12 Projector

Screen

STEP 11 Step of acquiring image data

STEP 12 Step of performing block zone dividing on image data

STEP 13 Step of detecting difference region between successive frames

STEP 14 Step of extracting image data of transmission region and then coding data

STEP 15 Step of transmitting coded image data via network

STEP 16 Step of determining whether block is last block

STEP 17 Step of releasing acquired image data region

STEP 18 Step of determining termination of this application

21 Personal computer

22 Screen

23 Block

24 Difference detection block

25 Difference region between frames

STEP 21 Step of receiving signal via network

STEP 22 Step of decoding received signal in method corresponding to coding method

STEP 23 Step of displaying decoded image data

31 Projector

32 Memory

32B Decoder

32C Projecting section

32D LAN interface

41 Personal computer

42 Projector

43 Screen

51A Receiving step for image data of first block

51B Decoding step for image data of first block

52A Receiving step for image data of second block

52B Decoding step for image data of second block

53A Receiving step for image data of third block

53B Decoding step for image data of third block

54A Receiving step for image data of fourth block

54B Decoding step for image data of fourth block

61 Personal computer

62 Screen

63 Transmission region

64 Difference region

### FOR CARRYING OUT THE INVENTION

Embodiments of the present invention are described below with reference to the drawings.

(Embodiments 1)

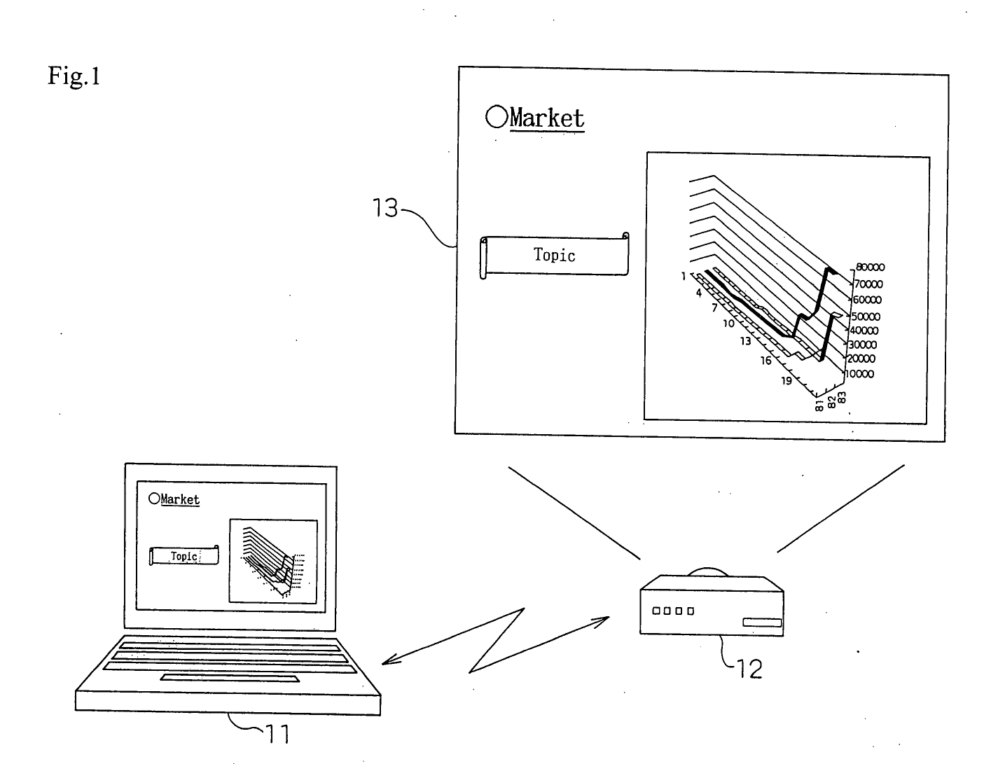

FIG. 1 is a diagram showing a mode of a system of implementing an image processing method of the present invention. Numeral 11 is a PC (personal computer) capable of transmitting a signal through a wireless LAN interface. Numeral 12 indicates a liquid crystal display projector that has a wireless LAN interface of receiving a signal and that can decode the received signal and then project the obtained image data. Numeral 13 indicates a screen of displaying the image projected from the liquid crystal display projector. That is, the present embodiment relates to a video display system provided with a video signal generating apparatus such as a PC of generating a video signal and with a display apparatus such as a projector and a display and, in particular, to a video display system of network input method in which a video signal generated by a PC, a camera, or the like is transmitted to and displayed on a display apparatus via a wireless LAN (Local Area Network) or the like.

In this system, the PC 11 acquires screen data displayed on a display of the PC 11. Here, the screen data is a video signal constructed with a plurality of frames. Then, the PC 11 detects regions (referred to as difference regions, hereafter) where a difference arises as a result of comparison with the immediately preceding frame when the screen data is regarded as video images. The PC 11 then acquires a transmission region which is the minimum rectangular region including the detected difference regions. Then, image data of the transmission region is extracted from the screen data. The image data extracted here is coded by means of compression or the like. Then, the coded data is transmitted via the LAN interface. The PC 11 performs this operation.

Further, the projector 12 receives the signal via the LAN interface, then decodes the received signal, thereby acquires image data, and then projects image data updated with the image data.

The present description is given for an example employing the projector 12. However, the display unit may be replaced by a CRT display, a plasma display, a liquid crystal display, a DLP projector, or the like.

Further, the present example employs the LAN interface. Here, the mode of the LAN may be wireless or alternatively wired. Then, in the case of a wireless LAN, its operation mode may be an ad hoc mode of peer to peer or alternatively an infrastructure mode.

Further, the present description is given for an example employing the PC 11. However, the PC 11 may be replaced by a terminal provided with a LAN interface and having screen data or alternatively by a small portable terminal such as a portable telephone.

Further, the apparatus of generating the video signal may be a small attachment part having the functions of: acquiring image data from a TV, a VTR, or the like; detecting and extracting difference regions relative to the immediately preceding frame; obtaining a transmission region which is the minimum rectangular region including the difference regions; acquiring image data in the transmission region; and coding and transmitting the data to the network. Alternatively, the apparatus may be a TV or a VTR having these functions.

Further, the present description is given for an example employing the LAN interface. However, the interface may be an interface such as Bluetooth connected to a system in which a network can be constructed.

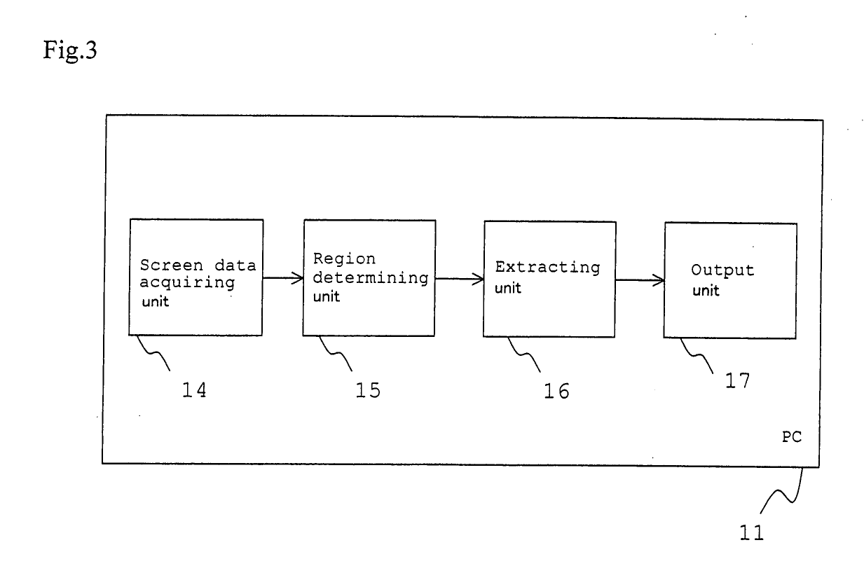

FIG. 3 is a block diagram showing the configuration of the PC 11.

Numeral 14 indicates a screen data acquiring unit acquiring the screen data of the PC 11. Numeral 15 indicates a region determining unit 15 calculating a transmission region for each block. Numeral 16 indicates an extracting unit 16 extracting the video signal included in the determined transmission region. Numeral 17 indicates an output unit transmitting the extracted video signal. Here, these pieces of unit may be implemented by a program stored in a memory of the PC 11 and by a CPU of performing the program.

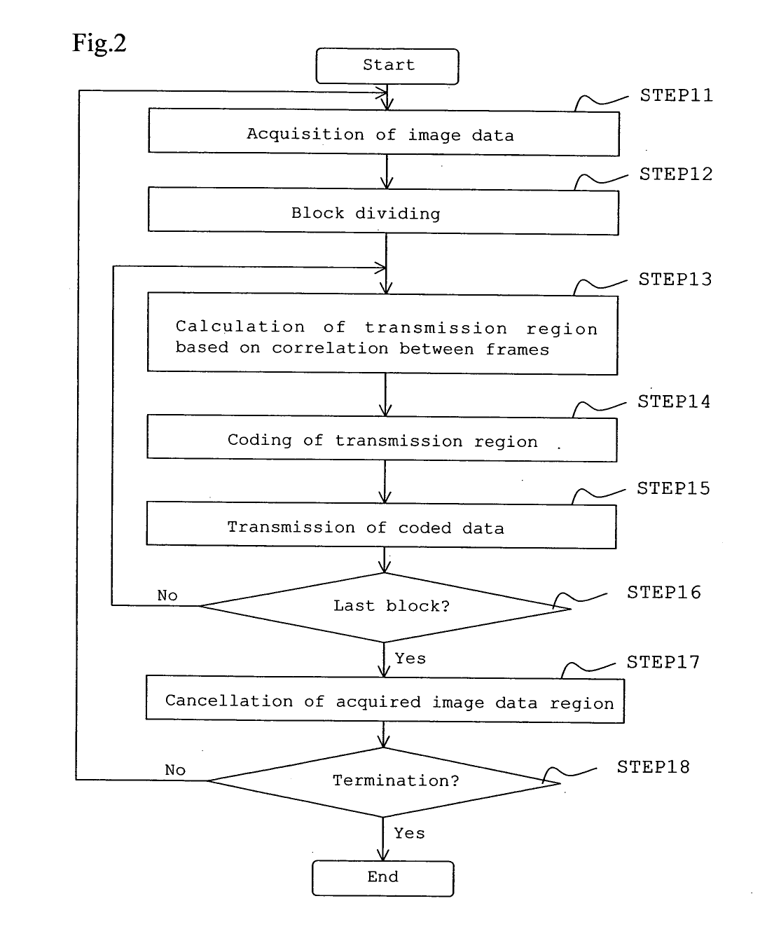

A method of transferring the screen image of the PC 11 of this system is described below. FIG. 2 is a flow chart showing the procedure of a method of transmitting an image signal according to the present embodiment. STEP 11 is a step that the screen data acquiring unit 14 captures as a whole the screen data of the PC 11, and thereby acquires the displayed screen image as image data into the memory.

STEP 12 is a step that the region determining unit 15 zone-divides the acquired image data into blocks.

STEP 13 is a step that the region determining unit 15 calculates a difference value from the immediately preceding frame within each block, thereby detects difference regions, and then obtains a transmission region which is the minimum rectangular region including the detected difference regions.

STEP 14 is a step that the extracting unit 16 extracts image data in the detected transmission region, then compress the extracted image data in a reversible coding method or alternatively an irreversible coding method, and thereby performs coding optimal for the transmission.

STEP 15 is a step that the output unit 17 transmits the coded signal data.

STEP 16 is a step that the region determining unit 15 determines whether the present block where the transmission region has been calculated is the last block in the screen and whether the transmission region has been calculated in all blocks. At this step, when detection of the transmission region in all blocks is not completed, the procedure returns to STEP 13.

STEP 17 is a step of canceling the screen data the transmission of which has been completed.

STEP 18 is a step of determining whether the processing using this screen image transmission system is to be terminated.

At STEP 11, the screen data acquiring unit 14 acquires the screen data of the PC 11. In general, the screen data is copied from a memory region having the data of the screen of the PC 11 to the main memory by using an API (Application Programming Interface) corresponding to the OS (Operating System).

At that time, in the acquisition (STEP 11) of the screen data, the screen data is acquired as a whole. This avoids screen separation possibly generated if the screen data were acquired in a divided manner. Further, a process of awaiting the acquisition process for the screen data until a signal is detected that is transmitted for the change of the screen image from a device driver or a kernel to the display unit may be inserted so that the load on the PC 11 may be reduced when no change is present on the screen. Further, not only from the API that depends on the OS, but also from a graphic driver, information concerning a newly rewritten portion of the screen data may be acquired so that the screen data of that region may solely be acquired efficiently. Further, when a plurality of monitors are present, a user can set up and select to acquire the image data of one of the monitors, the image data of some of the monitors, or the information of all image data of the monitors.

At STEP 12, the region determining unit 15 performs the zone dividing into blocks. Although depending on the coding method of the extracted image data, for example, when orthogonal transformation of 8×8 using matrices such as DCT (Discrete Cosine Transform) is performed like in the JPEG (Joint Photographic Experts Group) method, the size of at least 8 pixels by 8 pixels is necessary. Thus, in this case, efficiency is improved when the minimum unit of the block size is set to be 8 pixels so that the block detection is performed for the blocks having a size of a multiple of 8 pixels.

Further, although depending on the form of display in the projector or the like of outputting the image, in the case of a device that displays decoded image in the order of scanning lines, smooth screen switching is achieved when block zone dividing is performed only in the horizontal direction. The case that the block zone dividing is performed only in the horizontal direction is described later.

Nevertheless, when the block size is reduced so that the zone dividing is performed in to a larger number of blocks, overhead increases in the transmission. This increases the time necessary for the transmission, and hence degrades the immediacy. On the contrary, when a larger block size is adopted so that the zone dividing is performed into a smaller number of blocks, image data that is not a difference region is transferred more frequently as in the prior art. This can degrade the immediacy.

For example, when the screen resolution of the PC 11 is vertical 768 pixels by horizontal 1024 pixels, the optimal size of the block of zone dividing is horizontal 1024 pixels by vertical 96 pixels. Further, when the screen resolution of the PC 11 is vertical 600 pixels by horizontal 800 pixels, the optimal size of the block is vertical 150 pixels by horizontal 800 pixels. For the other screen resolutions, when the number of vertical pixels of the screen resolution is divisible by 8×8, the vertical block size is set to be ⅛ of the vertical screen resolution.

Further, in the case that the vertical screen resolution of the PC 11 is indivisible by 8×8 like in the above-mentioned case of vertical 600 pixels by horizontal 800 pixels, when the resolution is divisible by 8×5, the block size is set to be ⅕. In the other cases, resizing is performed. That is, the resolution is resized into a divisible value without changing the aspect ratio. Alternatively, the size is changed using black lines. Another method may be used.

Further, when the vertical and horizontal sizes of the screen resolution are indivisible by 8, a process of resizing or the like is performed similarly. If this process were omitted, a process of pixel complementing is added to the process in the DCT of JPEG. This increases the time necessary for the process, and hence degrades the immediacy.

At STEP 13, the region determining unit 15 detects difference regions relative to the immediately preceding frame for each block generated by zone-dividing the screen data into blocks, and then calculates a transmission region from the detected difference regions. The calculation of the transmission region is described below with reference to the drawings.

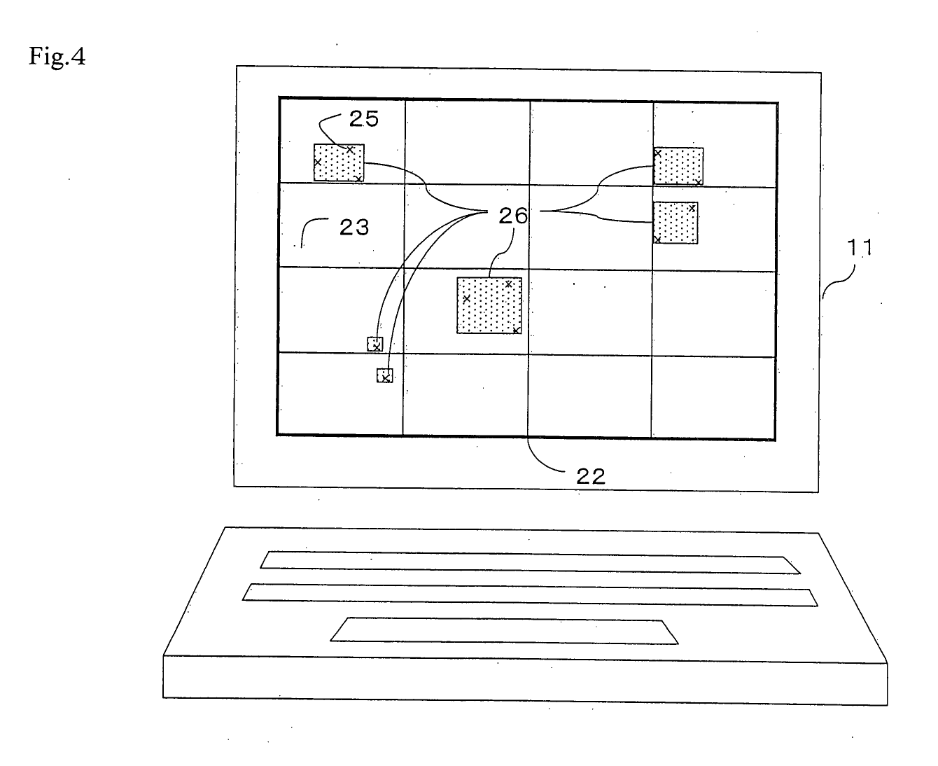

FIG. 4 show a model for a detection method for the transmission region by means of block zone dividing of the screen according to the embodiment. Numeral 11 indicates a PC having a screen. Numeral 22 indicates the screen of the PC. Numeral 23 indicates a block having a block size used in the zone dividing of the screen of the PC. In the present example, the vertical block size is ¼ of the vertical screen resolution, while the horizontal block size is ¼ of the horizontal screen resolution. Numeral 25 indicates a difference region where a difference is detected when compared with the immediately preceding frame. Here, in FIG. 4, the difference regions 25 are distributed in a point-like manner as indicated by “x” marks. However, the difference regions 25 may be distributed in a point-like manner, or alternatively in a manner composed of a plurality of adjacent pixels and hence having an area. Numeral 26 indicates a transmission region which is the minimum rectangular region including all difference regions within one block 23.

The screen 22 is processed on a block 23 basis. That is, the region determining unit 15 compares the image data of the immediately preceding frame with the present screen data in a block 23 for each block 23, and thereby detects regions where a difference is detected, that is, difference regions 25. Then, a transmission region 26 is derived which is the minimum rectangular region including the difference regions 25 detected in one block 23. That is, the minimum X coordinate and the maximum X coordinate of the difference regions 25 are acquired, while at the same time, the minimum Y coordinate and the maximum Y coordinate of the difference regions 25 are acquired. Then, the transmission region 26 is obtained as a rectangular region that has a diagonal line composed of a line segment connecting a point defined by the minimum X coordinate and the minimum Y coordinate with a point defined by the maximum X coordinate and the maximum Y coordinate.

At that time, if the zone dividing into blocks 23 were not performed, and if a transmission region to be transmitted were calculated from the upper right and the lower left coordinates of the difference regions, image data outside the difference regions, that is, image data which does not require transmission, would also be transferred. This could degrade the immediacy, and waste the network resources.

Further, if the contour lines of the detected difference regions were extracted so that grouping or combining of the difference regions were performed, a considerable time could be necessary for the arithmetic operations of this process. This could degrade the real time property and the immediacy.

Thus, in the present embodiment, since the region determining unit 15 processes the screen 22 on a block 23 basis, the above-mentioned problems do not arise.

At STEP 14, the extracting unit 16 extracts the image data of the transmission region 26 which is the minimum rectangle including the detected difference regions 25, and then codes the extracted image data. First, the extracting unit 16 acquires a transmission region 26 which is the minimum rectangular region including the difference regions 25 detected in the block 23, and then extracts the image data of the transmission region 26.

The image data extracted here is coded in a method appropriate for the transmission. When the data (the original data before compression) of a white board were transferred intact, the data would become notably large. This could increase the time necessary for the transmission, and occupy the network resources. Thus, a heavy load could arise on the network. Thus, the data is compressed so that the data to be transferred is reduced. This reduces the time for the transmission and the load on the network.

As for the mode of compression, reversible compression and irreversible compression of the image may be used selectively depending on the situation for each block 23, so that an application may be provided. Further, in the case of JPEG coding, the JPEG compression ratio is variable. Thus, the compression ratio can efficiently be changed depending on the purpose, or alternatively on the basis of automatic determination of the situation.

At STEP 15, the output unit 17 transfers via the network the data generated by coding the screen data extracted from the transmission region 26.

At STEP 16, it is determined whether the present block 23 in which search, extraction, coding, and transmission of a transmission region 26 have been performed is the last block. When a block 23 is present in which transfer is not yet performed, the process goes to the block 23, and then the procedure is performed starting at STEP 13. The optimal order of operation for the blocks would be the order of raster scan starting at the upper left.

At STEP 17, the memory region storing the acquired image data, the extracted image data, and the data area where the transmission has been completed are released. This process avoids the lack of system resources on the PC 21 side, and permits efficient memory usage. At STEP 18, it is determined whether a signal of termination has been received from the user. When a signal of termination is received from the user, the application need be terminated. Thus, the procedure goes to a termination process. When no signal of termination is received, the process need be continued. Thus, the next screen data is acquired, and then the procedure is repeated successively. When no signal is received, the procedure goes to STEP 11, and then executed. Alternatively, the extraction, the coding, and the transmission may be performed after the transmission region in each block is calculated in all blocks. In this extracting process, when a transmission region extends over adjacent blocks, a single transmission region can be generated using the correlation relation between the blocks. This point is described later in detail in Embodiment 3.

As such, in the present embodiment, zone dividing of the screen is performed on a block basis. Then, difference regions relative to the preceding frame are acquired on a block basis. Thus, difference regions present at distant positions can be regarded as independent regions. This reduces the occasion of transmitting a region that is not a difference region.

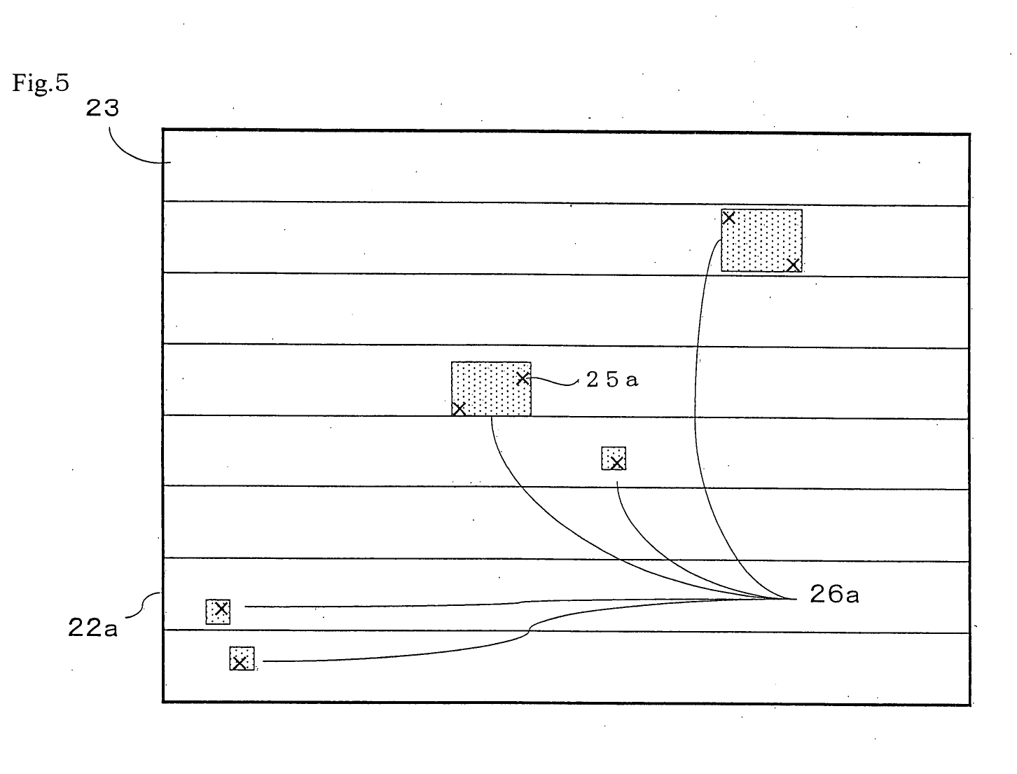

Further, as described above, although depending on the form of display in the projector or the like of outputting the image, in the case of a device that displays decoded image in the order of scanning lines, smooth screen switching is achieved when block zone dividing is performed only in the horizontal direction. FIG. 5 shows an example of a screen of a case that the block zone dividing is performed only in the horizontal direction as such.

In FIG. 5, the direction from the left to the right of the screen 22a is the direction of scanning lines. In this case, the blocks 23 are arranged in such a manner that the zone dividing is performed in a direction perpendicular to the direction scanned when the projector 12 having received a transmitted video signal displays the video signal. That is, the horizontal length of the block 23 agrees with the horizontal span of the screen 22a, while the vertical length of the block 23 agrees with a length generated by zone-dividing the vertical span of the screen 22a into eight equal parts. Further, in FIG. 5, numeral 25a indicates a difference region, while numeral 26a indicates a transmission region.

Further, the present embodiment has been described for the case that the screen data is a video signal constructed with a plurality of frames. However, the invention is not limited to this. The video signal may be constructed with a plurality of even number fields and odd number fields. When the screen data is a video signal constructed with a plurality of even number fields and odd number fields, the region determining unit 15 may compare each block of a predetermined even number field or odd number field of the video signal constructed with even number fields and odd number fields with each block corresponding to the block within an immediately preceding even number field or odd number field of the predetermined even number field or odd number field, and thereby determine a rectangular region including the regions having a different pixel value.

Further, the present embodiment has been described for the case that the screen data is generated by a process that a video signal displayed on the screen of the PC 11 is acquired by the screen data acquiring unit 14. However, the video signal may be inputted from the outside to the PC 11.

Further, the present embodiment has been described for the case that the extracting unit 16 extracts the image data of the transmission region 26, and then codes the extracted image data. However, the invention is not limited to this. The extracting unit 16 may extract the image data of the transmission region 26, and then output the extracted image data intact to the output unit 17. That is, the image data may be transmitted to the projector 12 without coding.

Further, the present embodiment has been described for the case that the output unit 17 transmits the image data of the transmission region 26 to the projector 12. However, the present invention is not limited to this. The output unit 17 may output the image data of the transmission region 26 to a recording media such as a hard disk.

Further, the present embodiment has been described for the case that the transmission region 26 is the minimum rectangular region that includes all difference regions 25 included in one block 23. However, the present invention is not limited to this. The transmission region 26 need not be the minimum rectangular region, as long as it is a rectangular region that includes all difference regions 25 included in one block 23.

Further, the image data of the present embodiment is an example of a video signal of the present invention. The difference region of the present embodiment is an example of a region of the present invention. The transmission region of the present embodiment is an example of a rectangular region of the present invention.

(Embodiment 2)

FIG. 1 is a diagram showing an embodiment of the present invention. Numeral 11 indicates a PC capable of transmitting a signal through a wireless LAN interface. Numeral 12 indicates a liquid crystal display projector that has a wireless LAN interface of receiving a signal and that can decode the received signal and then project the obtained image data. Numeral 13 indicates a screen of displaying the image projected from the liquid crystal display projector. Here, the PC 11 and the liquid crystal display projector 12 are the same as those of Embodiment 1. Further, the configuration of the PC 11 is shown is FIG. 3 similarly to Embodiment 1.

In this system, the PC 11 acquires the screen data displayed on the display of the PC 11. Or alternatively, when a secondary monitor is present, the PC 11 acquires the screen data of the primary monitor or the secondary monitor or both. Then, the PC 11 zone-divides the acquired video signal into blocks, and then detects regions (referred to as difference regions, hereafter) where a difference arises in comparison with the immediately preceding frame when the screen data is regarded as video images. Then, the PC 11 calculates a transmission region which is the minimum rectangular region including all difference regions within one block, and then extracts image data of the transmission region from the screen data. The image data extracted here is coded by means of compression or the like. Then, the coded data is transmitted via the LAN interface. The PC 11 performs this operation.

Further, the projector 12 receives the signal via the LAN interface, then decodes the received signal, thereby acquires image data, and then projects image data updated with the image data.

Further, the present description is given for an example employing the projector 12. However, the display unit may be replaced by a CRT display, a plasma display, a liquid crystal display, a DLP projector, or the like.

Further, the present example employs the LAN interface. Here, the mode of the LAN may be wireless or alternatively wired. Then, in the case of a wireless LAN, its operation mode may be an ad hoc mode of peer to peer or alternatively an infrastructure mode.

Further, the present description is given for an example employing the PC 11. However, the PC 11 may be replaced by a terminal provided with a LAN interface and having screen data or alternatively by a small portable terminal such as a portable telephone.

Further, the apparatus of generating the video signal may be a small attachment part having the functions of: acquiring image data from a TV, a VTR, or the like; detecting and extracting difference regions relative to the immediately preceding frame; calculating a transmission region which is the minimum rectangular region including the extracted difference regions; acquiring image data in the transmission region; and coding and transmitting the data to the network. Alternatively, the apparatus may be a TV or a VTR having these functions. Further, the present description is given for an example employing the LAN interface. However, the interface may be an interface such as Bluetooth connected to a system in which a network can be constructed.

In the present embodiment, the region determining unit 15 detects and extracts difference regions where a difference is present from the immediately preceding frame of the video image, and then calculates on a block basis a transmission region which is the minimum rectangular region including the extracted difference regions. Then, the video signal included in the extracted transmission region is solely transmitted through the output unit 17 through the wireless/wired LAN.

In the acquisition of the screen data, the screen data acquiring unit 14 copies the screen data displayed on the PC 11 into a main memory. At that time, the screen data is acquired not in a divided manner, but as a whole. This avoids screen separation, that is, a phenomenon that the image changes across a boundary line between zone-divided regions of a moving screen image such as a video image. The PC 11 performs these processes.

Further, the PC 11 may be replaced by a TV tuner, a DVD player, or a VTR that generates a video signal. In this case, a unit need be built in or attached that performs the processes of: zone-dividing the video signal into blocks; detecting difference regions between successive frames; calculating a transmission region which is the minimum rectangular region that includes all difference regions included in one block; extracting image data in the calculated transmission region; and then coding and transmitting the data.

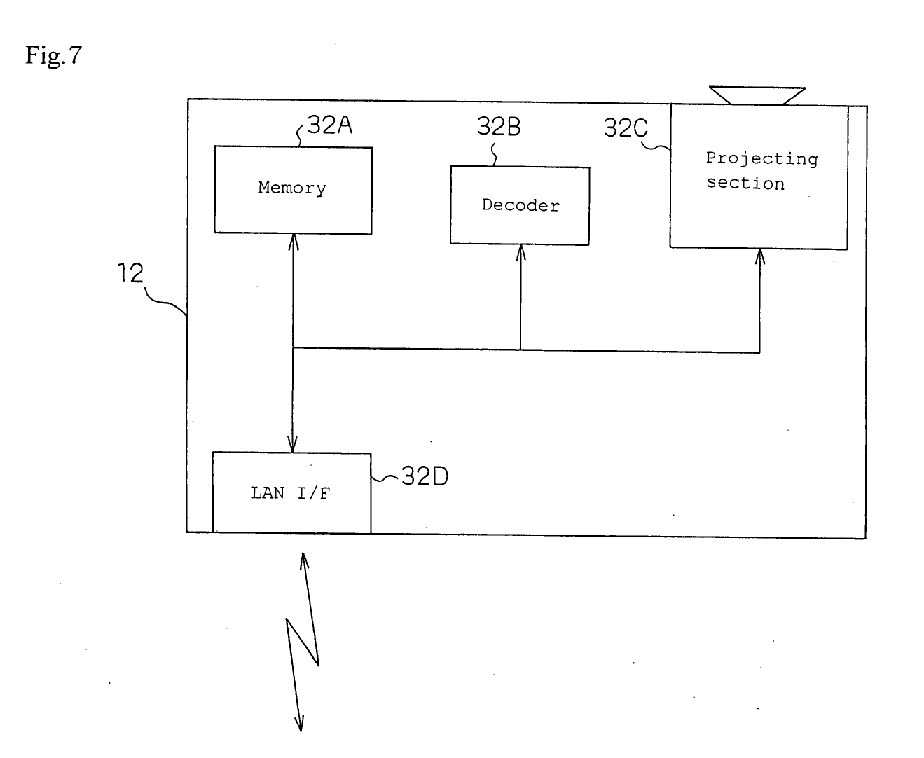

FIG. 7 is a block diagram showing the projector 12 of displaying the data transferred from the PC 11 via the network. Numeral 12 indicates a projector body. Numeral 32A indicates a memory of retaining and storing the transferred data, a processing program, and the like. Numeral 32B indicates a decoder of decoding the data having been coded and transmitted. Numeral 32C indicates a projecting section of projecting onto a screen the image data decoded by the decoder. Numeral 32D indicates a LAN interface of receiving the signal via the LAN.

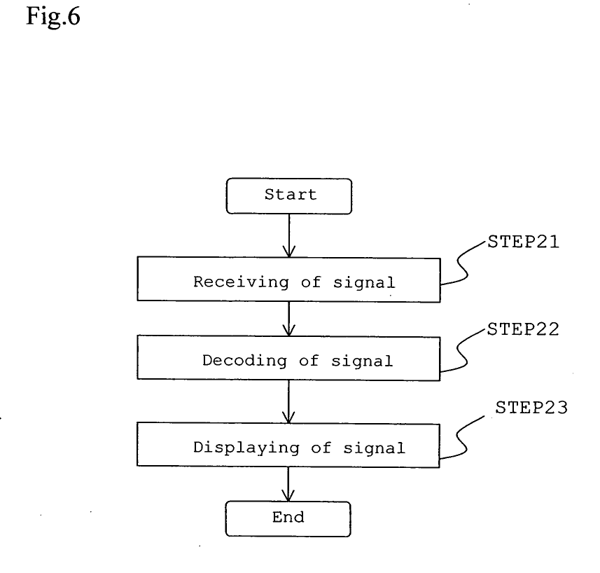

FIG. 6 shows the procedure of processing in this projector 12.

At STEP 21, the LAN interface 32D receives the data transmitted via the LAN, and then stores the data into the memory 32A.

At STEP 22, the received data stored in the memory 32A is transmitted to the decoder 32B. Then, the decoder 32B decodes the data.

At STEP 23, the projecting section 32C displays the decoded image data onto a display device.

In this system, the signal is transmitted from the LAN interface 32D. Coding has already been performed at that time. Thus, the image information, the encoding format, and the like are determined on the basis of the header information generated at the time of transmission. Then, the data is transmitted to the subsequent processing. As for the detailed values of the encoding format, the information is contained in the header of the image data. However, information is sufficient that merely specifies a decoder 32B to be used in the decoding of the signal. Then, the decoding is performed in a decoder 32B for the format specified by the header information of the receive data.

Further, a system is preferable that can perform the receiving step (STEP 21) and the decoding step (STEP 22) in parallel. At the displaying step (STEP 21), decoded image data acquired by decoding the signal is written into a memory region ensured as a video memory. At the time of completion of the write, a signal is transmitted to the display device, so that the display device displays the data stored in the video memory.

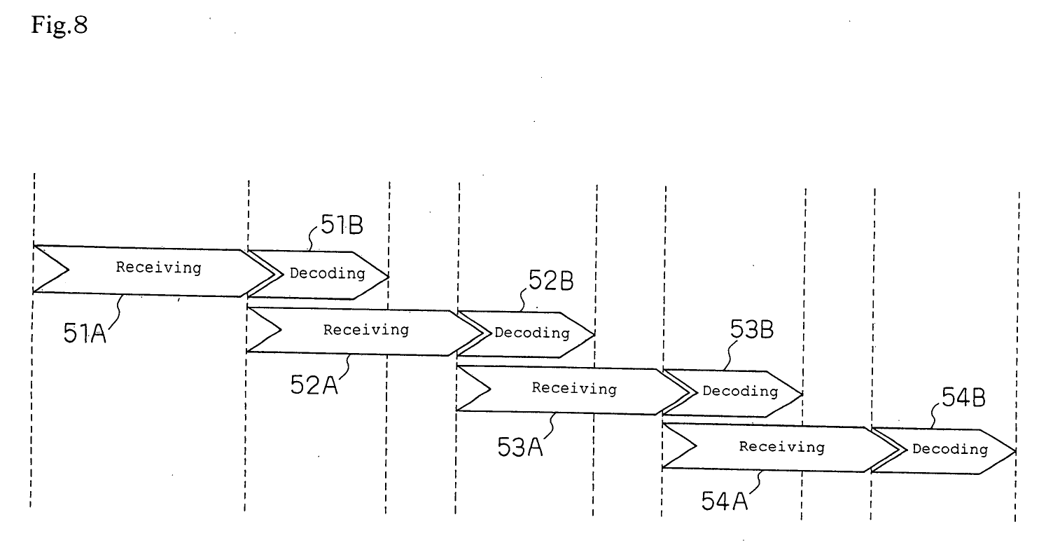

FIG. 8 shows an example of the process of zone-dividing the screen data on a block basis. In this system, during the receiving step (STEP 21), the process in the decoder 32B can be performed simultaneously. This is because a chip of controlling the decoder 32B is different from a chip of controlling the receiving through the LAN. Further, even in the case that the processing is to be controlled by the same chip, the processing is achieved by multiprocessing such as time sharing in a TSS (Time Sharing System) or the like.

When zone dividing of the screen is performed by 4 blocks, the transmitting side performs: detection of difference regions in the data of ¼ screen size; calculation of a transmission region from the detected difference regions; and coding and transmitting of the detected image data. Thus, processing on the receiving side becomes an occasional process.

Numeral 51A indicates a receiving operation for the image data of the first block. Numeral 51B indicates a decoding process for the first block. The decoding process cannot be performed until the entire signal is received. Further, in the case of transmission processing in a streaming movie form, received data is immediately transmitted to and decoded by the decoder in parallel to the receiving.

Numeral 52A indicates a receiving process for the second block. This process can be performed simultaneously with the process 51B. Numeral 52B indicates a decoding process for the second block.

Numeral 53A indicates a receiving process for the third block. At that time, the process 53A is performed simultaneously with the process 52B.

Numeral 54A indicates a receiving operation for the image data of the fourth block. This process is performed simultaneously with the process 53B. Numeral 54B indicates a decoding process for the fourth block.

In the present example, the processing time in the receiving process has been longer than in the decoding process. However, in the contrary case, the received data may be stored into a buffer so that the processing may be performed without stopping the receiving process. This system requires a unit capable of performing the above-mentioned processing.

Here, the projector 12 of the present embodiment is not limited to that having the above-mentioned configuration and operation. A projector used in the prior art maybe employed. In the present embodiment, a plurality of transmission regions merely arise per frame. Thus, a projector of any type is applicable to the present embodiment, as long as it has the function of receiving a video signal in which a predetermined transmission region is coded, as used in the prior art.

(Embodiment 3)

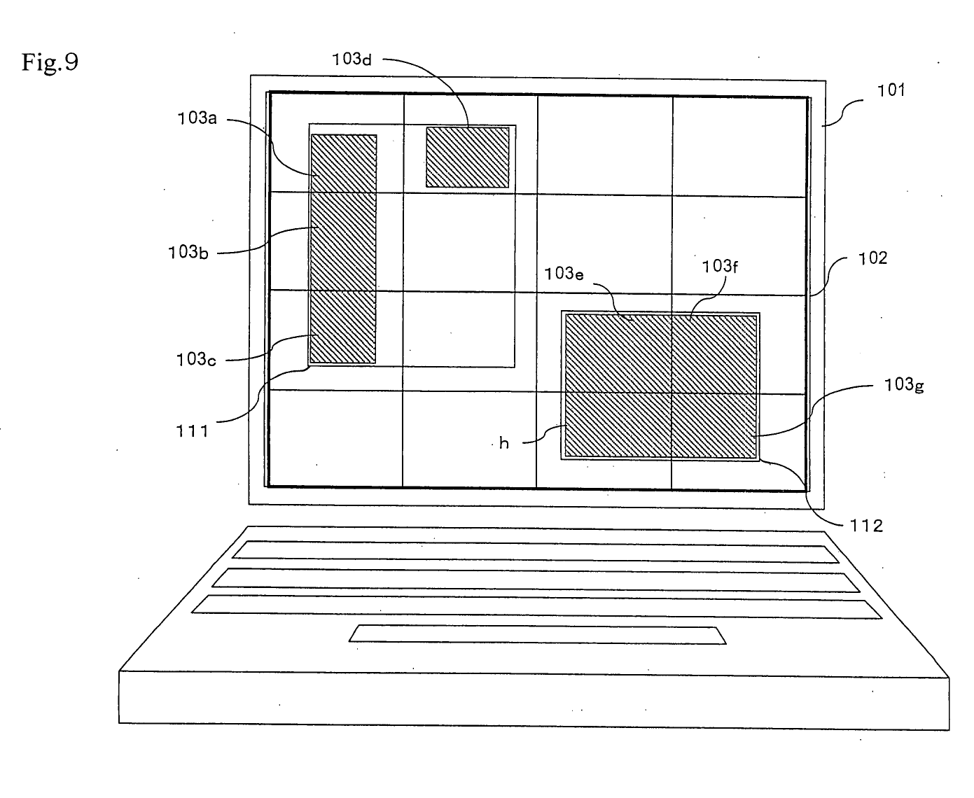

In FIG. 9, numeral 101 indicates a PC (personal computer). The PC has a display unit, and displays a screen image on the display unit. Numeral 102 indicates a displayed screen image. Then, when screen images are displayed successively, each of numerals 103a, 103b, 103c, 103d, 103e, 103f, 103g, and 103h indicates the minimum rectangular region including the portions having a change from the immediately preceding frame as a result of comparison with the immediately preceding frame. Each region is referred to as a transmission region also in Embodiment 3. In a case that a transmission region is detected in each block generated by dividing the screen into an arbitrary number, and that the data is transmitted respectively, a large overhead arises in the transmission and hence reduces the efficiency. Thus, transmission regions in adjacent blocks are grouped so that the transmission is performed on a group basis. This reduces the overhead in the transmission, and further avoids the display discrepancy in the displaying of the screen image on the receiving side. Each of numerals 111 and 112 is a grouped transmission region generated by grouping the transmission regions 103a, 103b, 103c, 103d, 103e, 103f, 103g, and 103h as described here. Described below is an algorithm of grouping for the generation of the grouped transmission regions 111 and 112. Here, this grouping algorithm is executed by the region determining unit 15 of FIG. 3.

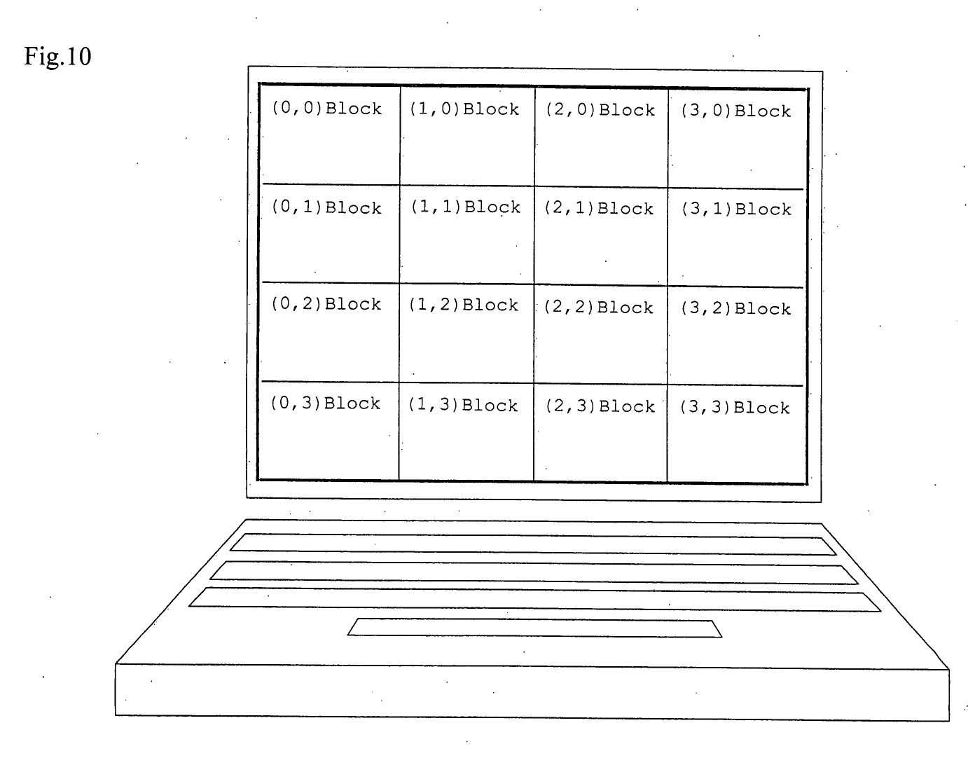

As shown in FIG. 10, the screen is zone-divided into blocks, and then a name is imparted to each block. The names are (0,0), (1,0), . . . starting at the upper left. Then, a transmission region is searched for each block. When a transmission region is present in the upper adjacent block and the left adjacent block, a group is generated with the transmission regions of the adjacent blocks. In this case, a determining method for the rectangular coordinates is that the most upper left coordinate is used as the minimum coordinate among the upper left coordinates of the rectangles and that the most lower right coordinate is used as the maximum coordinate of the rectangles. Here, the origin of the coordinate system provided on the screen 102 in FIG. 9 is the upper left corner of the screen 102. The positive direction of the X-axis is defined as the direction from the left to the right of the screen 102. The positive direction of the Y-axis is defined as the direction from the top to the bottom of the screen 102.

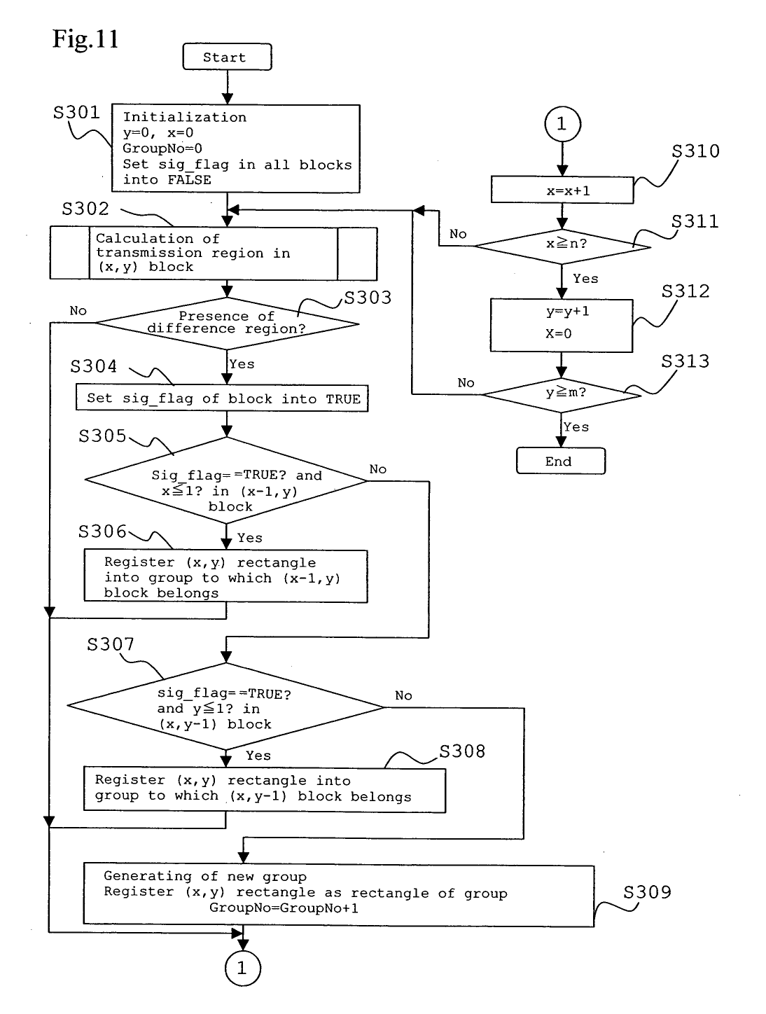

FIG. 11 is a flow chart of this processing. The numbers of zone dividing into blocks are assumed to be n in the horizontal direction and m in the vertical direction (in FIG. 10, the numbers of zone dividing are 4 in the horizontal direction and 4 in the vertical direction, for simplicity). Each block has: a sig₁₃ flag indicating the presence or absence of a difference region; and a parameter of the number of the group to which the block belongs. As a global parameter, a GroupNo is shared that indicates the number of groups in which transmission is to be performed. When the GroupNo is 0, no changed region is present, and hence no transmission is necessary.

STEP 301 is a step of initializing the sig_flag parameter and the group number of each block. At that time, X and Y parameters indicate the position of a presently pointed block.

STEP 302 is a step of detecting difference regions relative to the immediately preceding frame in a presently pointed block and thereby calculating a transmission region from the detected difference regions.

STEP 303 is a step of performing parameter determination on the basis of the executed result of STEP 302. When a transmission region is present in this block, the procedure goes to STEP 303. When not present, the procedure goes to STEP 310.

STEP 304 is a step of inputting the value of TRUE into the sig_flag when the processing result in STEP 302 is “presence of a transmission region”.

STEP 305 is a step of determining the parameter of the block adjacent on the right-hand side. At that time, this processing is not performed for the blocks located at the right-hand end of the screen. When the sig_flag of the block on the right is TRUE, the procedure goes to STEP 306. When FALSE, the procedure goes to STEP 307.

STEP 306 is a step of grouping the block presently under consideration with the block on the left. Then, in the process of grouping, the same group number as the block on the left is registered into the parameter owned by the block, and then the rectangle of the group is compared with the transmission region in the present block, so that values are set up such that the upper left coordinate is the minimum while the lower right coordinate is the maximum.

STEP 307 is a step of determining the parameter of the block adjacent on the upside. This step is not performed when a transmission region is present in the block on the left or alternatively when the block is located at the upper end of the screen. When the sig_flag parameter of the block on the upside is TRUE, the procedure goes to STEP 309. When FALSE, the procedure goes to STEP 310. STEP 308 is a step of grouping the block presently under consideration with the block on the upside. At that time and in the process of grouping, the same group number as the block on the upside is registered into the parameter owned by the block, and then the rectangle of the group is compared with the transmission region in the present block, so that values are set up such that the upper left coordinate is the minimum while the lower right coordinate is the maximum.

STEP 309 is a step of generating a new group when no transmission region is present in the adjacent blocks. A new group is generated, while the GroupNo parameter is incremented. Then, the transmission region of the group presently under consideration is registered into the newly generated group.

STEP 310 is a step of moving the to-be-considered block to the block on the right.

STEP 311 is a step of determining whether the block presently under consideration is located at the right-hand end. In the case that the block under consideration before the change is located at the left-hand end, when the result of increment of the parameter is greater than or equal to the number of zone dividing in the horizontal direction, no adjacent block is present on the right-hand side. Thus, it is determined that the block previously under consideration is located at the left-hand end. At that time, when the block under consideration before the parameter change is located at the right-hand end, the procedure goes to STEP 312. When not at the left-hand end, the procedure goes to STEP 302.

STEP 312 is a step of moving the to-be-considered block to the leftmost block in the lower adjacent row. STEP 313 is a step of determining whether the block presently under consideration before the parameter change at STEP 312 is located at the lower end. When the result of increment is greater than or equal to the number of zone dividing in the vertical direction, it is determined that the block under consideration before the parameter change is located at the lower end. At that time, when the block under consideration before the parameter change is located at the lower end, the procedure is completed. When not at the lower end, the procedure goes to STEP 302.

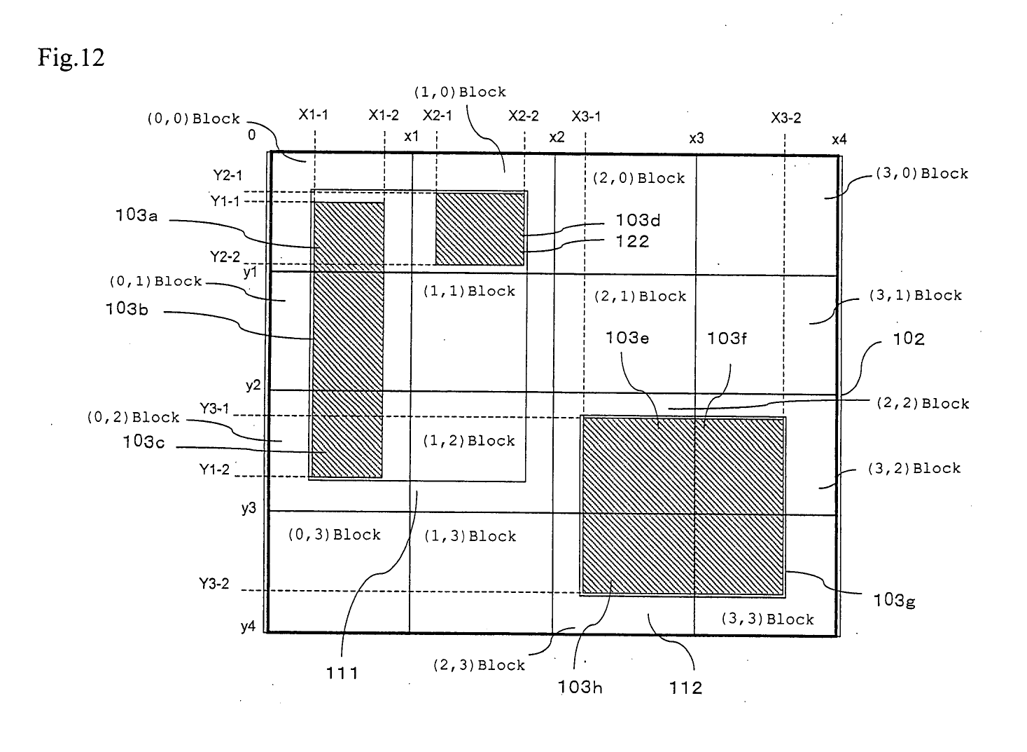

The following description is given for the example of FIG. 12. In FIG. 12, numeral 102 indicates the same screen as that of FIG. 9. At this time, the screen is zone-divided into blocks of 4×4, and then a name is imparted to each block. Initialization is performed, and then the grouping algorithm is executed. First, a transmission region 103a of the block (0,0) is calculated. At that time, the transmission region rectangle of this block becomes (X₁₋₁, Y₁₋₁)−(X₁₋₂, Y₁). This block has no adjacent block on the upside or the left-hand side. Thus, the first group is generated. This group is referred to as “group 1”. The rectangle (X₁₋₁, Y₁₋₁)−(X₁₋₂, Y₁) is registered into the group 1. Next, the block (1,0) is considered. The transmission region 103d of this block is (X₂₋₁, Y₂₋₁)−(X₂₋₂, Y₂₋₂). The transmission region 103a is present in the block on the left. Thus, the transmission region of the block (1,0) is added to the group 1 that includes the transmission region of the block on the left. Since X₁₋₁<X₂₋₂ and Y₁₋₁>Y₂₋₁, the upper left coordinate becomes (X₁₋₁, Y₂₋₁). Further, since X₁₋₂<X₂₋₂ and Y₁>Y₂₋₂, the lower right coordinate becomes (X₂₋₂, Y₁).

Similar processing is performed also on the block (2,0) and the block (3,0). Since no transmission region is present in these blocks, no grouping process is performed. Similar processing is performed in the order of (0,1), (1,1), (2,1), (3,1), (0,2), and (1,2). In the processing of the block (2,2), a transmission region 103e is present in this block. However, no transmission region is present in the block adjacent on the upside or the left-hand side. Thus, a new group referred to as “group 2” is generated. Then, at the time of completion of the processing of all blocks, two groups have been generated. At that time, the transmission rectangles are: the transmission region 111 (X₁₋₁, Y₂₋₁)−(X₂₋₂, Y₁₋₂) composed of the group 1; and the transmission region 112 (X₃₋₁, Y₃₋₁)−(X₃₋₂, Y₃₋₂) composed of the group 2.

As such, in the case that each of blocks adjacent in the horizontal or vertical direction has a transmission region determined by the region determining unit 15, overhead in the transmission can be reduced when the rectangular region that includes both of the transmission regions of the blocks adjacent in the horizontal or vertical direction is used as a grouped transmission region.

Further, in the above-mentioned method, as shown in FIG. 12, the transmission regions 103a, 103b, and 103c and the transmission region 103d are not connected with each other, but transmitted as a grouped transmission region 111 within the same group. At that time, the region between the transmission regions 103a, 103b, and 103c and the transmission region 103d need not be transmitted, but still transmitted. In order to resolve this problem, the following method may be used.

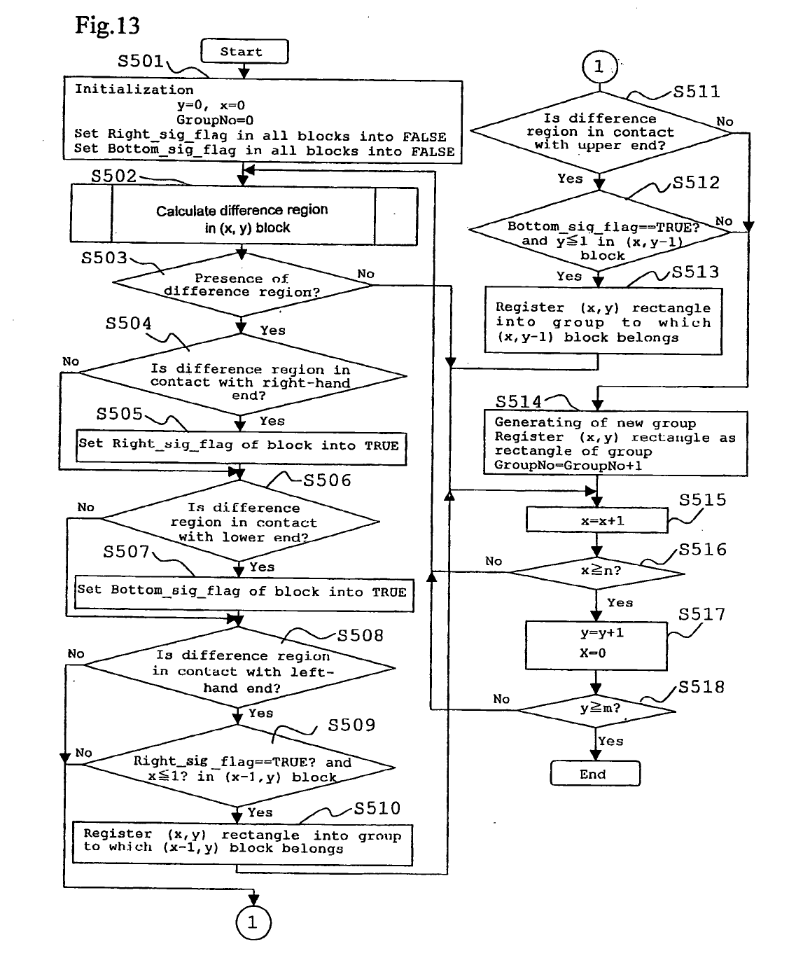

In this method, it is determined whether a transmission region extends across the boundary line with an adjacent block. The sequence of this algorithm is shown in FIG. 13. In FIG. 13, STEP 501 is a step of initialization. All the parameters of X, Y, and GroupNo are set to be 0, while the parameter of each block is initialized.

STEP 502 is a step of calculating a transmission region relative to the immediately preceding frame in the block.

STEP 503 is a step of detecting the presence or absence of a transmission region on the basis of the processing result of STEP 502 and then performing determination. When a transmission region is present in the block under consideration, the procedure goes to STEP 504. When not present, the procedure goes to STEP 515.

STEP 504 is a step of determining whether the transmission region in the block under consideration is in contact with the boundary line with the block on the right. At that time, when the transmission region is in contact with the boundary line with the block adjacent on the right-hand side, the procedure goes to STEP 505. When not in contact, the procedure goes to STEP 506.

STEP 505 is a step of imparting a parameter indicating that the transmission region of the block under consideration is in contact with the right-hand side boundary line. The parameter TRUE is set into the Right_sig_flag owned by this block.

STEP 506 is a step of determining whether the transmission region in this block is in contact with the boundary line with the block adjacent on the downside. At that time, when the transmission region in this block is in contact with the boundary line with the block adjacent on the downside, the procedure goes to STEP 507. When not in contact, the procedure goes to STEP 508.

STEP 507 is a step of imparting a parameter indicating that the transmission region of the block under consideration is in contact with the downside boundary line. The parameter TRUE is set into the Bottom_sig_flag owned by this block.

STEP 508 is a step of determining whether the transmission region of the block under consideration is in contact with the boundary line with the block adjacent on the upside. At that time, when the transmission region in this block is in contact with the boundary line with the block adjacent on the upside, the procedure goes to STEP 509. When not in contact, the procedure goes to STEP 511.

STEP 509 is a step of determining whether this block is not located at the left-hand end while the transmission region of the block on the left is in contact with the boundary line with the block under consideration. At that time, when this block is located at the left-hand end, no block is present on the left. Thus, no parameter determination is performed, so that the procedure goes to STEP 511. Further, as for the determination whether the transmission region of the block on the left is in contact with the boundary line with the block under consideration, the Right_sig_flag parameter of the block on the left is checked so that when the value of the parameter is TRUE, the procedure goes to STEP 510. When the parameter is FALSE, the procedure goes to STEP 511.

STEP 510 is a step of adding the transmission region in the block under consideration to the group to which the transmission region in the block on the left belongs. The method of adding the region to the group is the same as the above-mentioned method.

STEP 511 is a step of checking whether the transmission region in the block under consideration is in contact with the boundary line with the block adjacent on the upside. At that time, when the transmission region in the block is in contact with the boundary line with the block adjacent on the upside, the procedure goes to STEP 512. When not in contact, the procedure goes to STEP 514.

STEP 512 is a step of determining whether the block presently under consideration is not located at the upper end while the transmission region in the block on the upside is in contact with the boundary line with the block presently under consideration. When the block presently under consideration is located at the upper end, no adjacent block is present on the upside. Thus, parameter checking is unnecessary. At that time, the procedure goes to STEP 514. Further, when this block is not located at the upper end, it is determined whether the transmission region in the block adjacent on the upside is in contact with the boundary line with the block under consideration, on the basis of the Bottom_sig_flag parameter on the upside. At that time, when the Bottom_sig_flag parameter is TRUE, the procedure goes to STEP 513. When FALSE, the procedure goes to STEP 514.

At STEP 513, the transmission region in the block under consideration is added to the group to which the transmission region in the block adjacent on the upside belongs. The process of addition is similar to the above-mentioned method.

STEP 515 is a step of moving the to-be-considered block to the right block. The X parameter is incremented.

STEP 516 is a step of determining whether the value of X is greater than or equal to the number of zone dividing in the horizontal direction. At that time, when the incremented value of X is greater than or equal to the number of zone dividing in the horizontal direction, the block under consideration before the parameter change is the block located at the right-hand end. Thus, the procedure cannot go to the right. At that time,when the value of the parameter is greater than or equal to the number of horizontal zone dividing, the procedure goes to STEP 517. When the value of the parameter is smaller than the number of horizontal zone dividing, the procedure goes to STEP 502.

STEP 517 is a step of moving the procedure having reached the rightmost end to the block located at the left-hand end of the next row. The value of the Y parameter is incremented, while the value of the X parameter is set to be 0.

STEP 518 is a step of determining whether the incremented Y parameter is greater than or equal to the number of zone dividing in the vertical direction. At that time, when the value of the Y parameter is greater than or equal to the number of zone dividing in the vertical direction, the procedure is located at the lowermost edge. Thus, the processing cannot be moved to the yet lower block. This is the purpose of this determination. When the value of the Y parameter is smaller than the number of zone dividing in the vertical direction, the procedure goes to STEP 502. When the value is greater than or equal to the number, the procedure is completed.

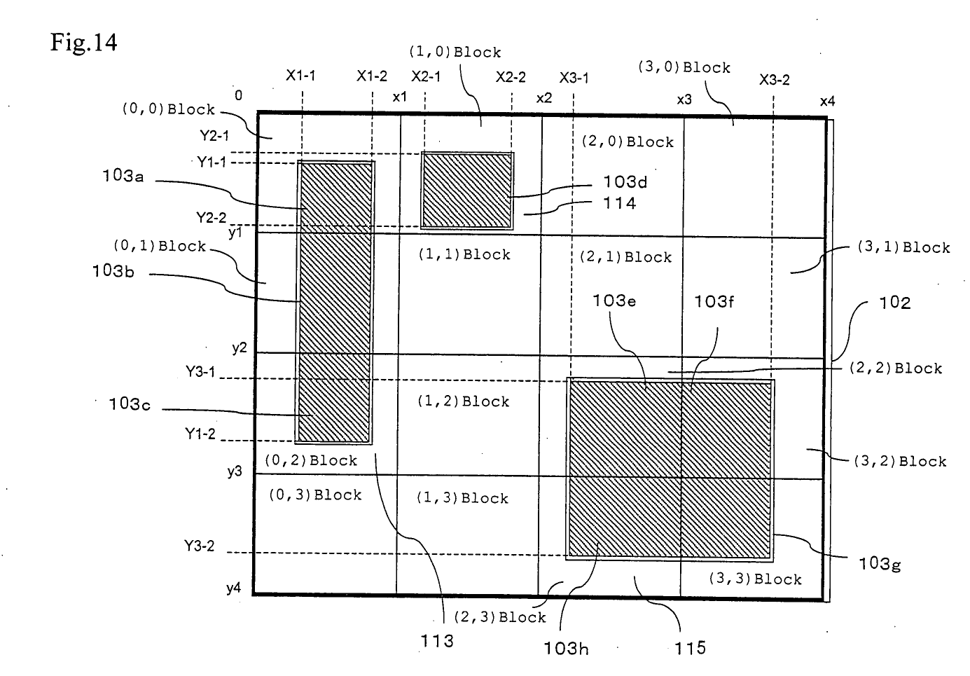

An example of this algorithm is described below with reference to FIG. 14. First, initialization is performed. Then, difference search and grouping are performed starting at the block (0,0). The block (0,0) has a transmission region (X₁₋₁, Y₁₋₁)−(X₁₋₂, Y₁) as the transmission region 103a. This transmission region 103a is not in contact with the boundary line with the block 103d adjacent on the right-hand side, but is in contact with the boundary line with the block 103b adjacent on the downside. Thus, the value of TRUE is set into the Bottom_sig_flag parameter of this group. Further, this block has no adjacent block on the left-hand side or the upside. Thus, a group (group 1) is generated newly, while the rectangle of the transmission region owned by this block is used as the rectangle of the group. Then, the procedure goes to the next block. The block (1,0) has a transmission region (X₂₋₁, Y₂₋₁)−(X₂₋₂, Y₂₋₂) as the transmission regions 103d. The transmission region 103d in this block is not in contact with the boundary line with the block adjacent on the right-hand side or the downside. Thus, no change is caused in the parameter. Further, this transmission region 103d is not in contact with the boundary line with the block adjacent on the upside or the left-hand side. Thus, a new group (group 2) is generated, while the transmission region 103d of the group under consideration is added to this group. Since no transmission region is present in the block (0,2) and the block (0,3), no grouping process is performed. The block (1,0) has a transmission region (X₁₋₁, Y₁)−(X₁₋₂, Y₂)as the transmission regions 103b. This transmission region 103b is in contact with the boundary line with the adjacent block on the downside. Thus, the value of the Bottom_sig_flag parameter is set to be TRUE. Further, this transmission region 103b is in contact with the boundary line with the block on the upside. At the same time, the Bottom_sig_flag parameter of the block on the upside is TRUE. Thus, the transmission region of the block under consideration is added to the group 1 to which the transmission region 103a in the block on the upside belongs. After that, this processing is performed until reaching the last block (3,3). As a result of this processing, three grouped transmission regions 113, 114, and 115 are obtained.

As such, in the case that each of blocks adjacent in the horizontal or vertical direction has a transmission region determined by the region determining unit 15 and that these rectangular regions are in contact with each other in the horizontal or vertical direction, overhead in the transmission can be reduced when a rectangular region that includes both of the transmission regions of the blocks adjacent in the horizontal or vertical direction is used as a grouped transmission region.

According to the present embodiment, in a system of transmitting screen data on a PC screen to a display unit such as a projector in real time, the screen data is processed in a zone-divided manner. This allows difference regions relative to the immediately preceding frame to be detected in detail, and hence avoids the transmission of unnecessary information. This reduces the time necessary for the transmission and the overall processing time in the real-time transmission. Thus, the load on the network is reduced, and so is the load on the PC in the transmission to the network. Further, the load of network processing is reduced on the display system in the receiving from the network.

Further, according to the present embodiment, the screen data is divided and transmitted in parallel. Thus, decoding can be performed in parallel to the receiving. This remarkably reduces the processing time, and hence maintains the real time property and the immediacy.

Here, the grouped transmission region of the present embodiment is an example of a rectangular region obtained from a determined rectangular region by applying a predetermined rule.

The program of the present invention is a program which causes a computer to perform the function of all or a part of the unit of the transmitting apparatus of the present invention described above, and which operates in cooperation with the computer.

The recording medium of the present invention is a computer-readable recording medium which carries a program of causing a computer to perform the function of all or a part of the unit of the transmitting apparatus of the present invention described above, wherein said program having been read out performs said function in cooperation with said computer.

Said phrase “a part of the unit” of the present invention indicates a piece or pieces of unit among plural pieces of the unit.

Said phrase “the function of unit” of the present invention indicates all or a part of the function of said unit.

A mode of use of the program according to the present invention may be that the program is recorded in a computer-readable recording medium and operates in cooperation with a computer.

A mode of use of the program according to the present invention may be that the program is transmitted through a transmitting medium, read out by a computer, and operates in cooperation with the computer.

The scope of the recording medium includes a ROM, while the scope of the transmitting medium includes: a transmitting medium such as the Internet; and light, radio waves, and acoustic waves.

The above-mentioned computer according to the present invention is not restricted to genuine hardware such as a CPU, and may be firmware, an OS, and a peripheral device.

As described above, the configuration according to the present invention may be implemented by software or hardware.

As seen from the description given above, the invention provides a transmitting apparatus, an image processing system, an image processing method, a program, and a recording medium in which no increase is caused in the amount of image data to be transmitted, and in which no load increase is caused in the traffic so that no degradation is caused in the immediacy necessary for real-time transmission.

1-21. (canceled)

22. A transmitting apparatus of outputting a video signal generated by a video signal generating apparatus of generating said video signal constructed with frames, to a receiving apparatus having a receiving unit receiving a transmitted video signal and an output unit outputting said received video signal by means of scanning lines, said apparatus comprising:
a block dividing unit zone-dividing said frame into a predetermined number of blocks in parallel to the scanning lines of said output unit of said receiving apparatus;
a region determining unit comparing each block of said predetermined frame generated by said block dividing unit with each block corresponding to the block within an immediately preceding frame of said predetermined frame, and thereby determining a rectangular region having a different pixel value;
an extracting unit extracting a video signal included in (1) the determined rectangular region or (2) a rectangular region obtained from the determined rectangular region by applying a predetermined rule; and
a transmitting unit coding the video signal extracted by said extracting unit and then transmitting the signal to said receiving apparatus.

23. A transmitting apparatus of outputting a video signal generated by a video signal generating apparatus of generating said video signal constructed with even number fields and odd number fields, to a receiving apparatus having a receiving unit receiving a transmitted video signal and an output unit outputting said received video signal by means of scanning lines, said apparatus comprising:
a block dividing unit zone-dividing said even number field or odd number field into a predetermined number of blocks in parallel to the scanning lines of said output unit of said receiving apparatus;
a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value;
an extracting unit extracting a video signal included in (1) the determined rectangular region or (2) a rectangular region obtained from the determined rectangular region by applying a predetermined rule; and
a transmitting unit coding the video signal extracted by said extracting unit and then transmitting the signal to said receiving apparatus.

24. A transmitting apparatus according to claim 22, wherein said predetermined rule is that when each of said blocks adjacent in a horizontal or vertical direction has a rectangular region determined by said region determining unit, a rectangular region is generated that includes both of the rectangular regions of said blocks adjacent in a horizontal or vertical direction.

25. A transmitting apparatus according to claim 24, wherein said region that includes both of the rectangular regions of said blocks adjacent in a horizontal or vertical direction indicates a minimum rectangular region that includes both of said rectangular regions of said blocks adjacent in a horizontal or vertical direction.

26. A transmitting apparatus according to claim 23, wherein said predetermined rule is that when each of said blocks adjacent in a horizontal or vertical direction has a rectangular region determined by said region determining unit, a rectangular region is generated that includes both of the rectangular regions of said blocks adjacent in a horizontal or vertical direction.

27. A transmitting apparatus according to claim 26, wherein said 7 region that includes both of the rectangular regions of said blocks adjacent in a horizontal or vertical direction indicates a minimum rectangular region that includes both of said rectangular regions of said blocks adjacent in a horizontal or vertical direction.

28. A transmitting apparatus according to claim 22, wherein said predetermined rule is that when each of said blocks adjacent in a horizontal or vertical direction has a rectangular region determined by said region determining unit and when these rectangular regions contact with each other in a horizontal or vertical direction, a rectangular region is generated that includes both of the rectangular regions of said blocks adjacent in a horizontal or vertical direction.

29. A transmitting apparatus according to claim 28, wherein said rectangular region that includes both of the rectangular regions of said blocks adjacent in a horizontal or vertical direction indicates a minimum rectangular region that includes both of said rectangular regions of said predetermined blocks adjacent in a horizontal or vertical direction.

30. A transmitting apparatus according to claim 23, wherein said predetermined rule is that when each of said blocks adjacent in a horizontal or vertical direction has a rectangular region determined by said region determining unit and when these rectangular regions contact with each other in a horizontal or vertical direction, a rectangular region is generated that includes both of the rectangular regions of said blocks adjacent in a horizontal or vertical direction.

31. A transmitting apparatus according to claim 30, wherein said rectangular region that includes both of the rectangular regions of said blocks adjacent in a horizontal or vertical direction indicates a minimum rectangular region that includes both of said rectangular regions of said predetermined blocks adjacent in a horizontal or vertical direction.

32. A transmitting apparatus according to claim 22, wherein said region determining unit determines said rectangular region in parallel to the scanning lines of said output unit of said receiving apparatus.

33. A transmitting apparatus according to claim 23, wherein said region determining unit determines said rectangular region in parallel to the scanning lines of said output unit of said receiving apparatus.

34. A transmitting apparatus according to claim 22, wherein:
said transmitting apparatus serves also as said video signal generating apparatus;
said transmitting apparatus and said video signal generating apparatus are a personal computer; and
said receiving apparatus is a liquid crystal display projector, a DLP projector, or a PDP.

35. A transmitting apparatus according to claim 23, wherein:
said transmitting apparatus serves also as said video signal generating apparatus;
said transmitting apparatus and said video signal generating apparatus are a personal computer; and
said receiving apparatus is a liquid crystal display projector, a DLP projector, or a PDP.

36. An image processing system comprising:
a receiving apparatus having a receiving unit receiving a transmitted video signal and an output unit outputting said received video signal by means of scanning lines;
a video signal generating apparatus of generating a video signal constructed with frames;
a transmitting apparatus having: a block dividing unit zone-dividing said frame into a predetermined number of blocks in parallel to the scanning lines of said output unit of said receiving apparatus; a region determining unit comparing each block of said predetermined frame generated by said block dividing unit with each block corresponding to the block within an immediately preceding frame of said predetermined frame, and thereby determining a rectangular region having a different pixel value; an extracting unit extracting a video signal included in (1) the determined rectangular region or (2) a rectangular region obtained from the determined rectangular region by applying a predetermined rule; and a transmitting unit coding the video signal extracted by said extracting unit and then transmitting the signal to said receiving apparatus.

37. An image processing system according to claim 36, wherein:
said transmitting apparatus serves also as said video signal generating apparatus;
said video signal generating apparatus and said transmitting apparatus are a personal computer; and
said receiving apparatus is a liquid crystal display projector, a DLP projector, or a PDP.

38. An image processing system comprising:
a receiving apparatus having a receiving unit receiving a transmitted video signal and an output unit outputting said received video signal by means of scanning lines;
a video signal generating apparatus of generating a video signal constructed with even number fields and odd number fields; and
a transmitting apparatus having: a block dividing unit zone-dividing said even number field or odd number field into a predetermined number of blocks in parallel to the scanning lines of said output unit of said receiving apparatus; a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value; an extracting unit extracting a video signal included in (1) the determined rectangular region or (2) a rectangular region obtained from the determined rectangular region by applying a predetermined rule; and a transmitting unit coding the video signal extracted by said extracting unit and then transmitting the signal to said receiving apparatus.

39. An image processing system according to claim 38, wherein:
said transmitting apparatus serves also as said video signal generating apparatus;
said video signal generating apparatus and said transmitting apparatus are a personal computer; and
said receiving apparatus is a liquid crystal display projector, a DLP projector, or a PDP.

40. An image processing method of outputting a video signal generated by a video signal generating apparatus of generating said video signal constructed with frames, to a receiving apparatus having a receiving unit receiving a transmitted video signal and an output unit outputting said received video signal by means of scanning lines, said method comprising:
a block dividing step of zone-dividing said frame into a predetermined number of blocks in parallel to the scanning lines of said output unit of said receiving apparatus;
a region determining step of comparing each block of said predetermined frame generated at said block dividing step with each block corresponding to the block within an immediately preceding frame of said predetermined frame, and thereby determining a rectangular region having a different pixel value;
an extracting step of extracting a video signal included in (1) the determined rectangular region or (2) a rectangular region obtained from the determined rectangular region by applying a predetermined rule; and
a transmitting step of coding the video signal extracted at said extracting step and then transmitting the signal to said receiving apparatus.

41. An image processing method of outputting a video signal generated by a video signal generating apparatus of generating said video signal constructed with even number fields and odd number fields, to a receiving apparatus having a receiving unit of receiving a transmitted video signal and an output unit of outputting said received video signal by means of scanning lines, said method comprising:
a block dividing step of zone-dividing said even number field or odd number field into a predetermined number of blocks in parallel to the scanning lines of said output unit of said receiving apparatus;
a region determining step of comparing each block of said even number field or odd number field generated at said block dividing step with each block corresponding to the block within an immediately preceding even number field or odd number field of said predetermined even number field or odd number field, and thereby determining a rectangular region having a different pixel value;
an extracting step of extracting a video signal included in (1) the determined rectangular region or (2) a rectangular region obtained from the determined rectangular region by applying a predetermined rule; and
a transmitting step of coding the video signal extracted at said extracting step and then transmitting the signal to said receiving apparatus.

42. A computer-processible recording medium having a program of causing a computer to serve, in a transmitting apparatus according to claim 22, as:
a block dividing unit zone-dividing said frame into a predetermined number of blocks in parallel to the scanning lines of said output unit of said receiving apparatus;
a region determining unit comparing each block of said predetermined frame generated by said block dividing unit with each block corresponding to the block within an immediately preceding frame of said predetermined frame, and thereby determining a rectangular region having a different pixel value;
an extracting unit extracting a video signal included in (1) the determined rectangular region or (2) a rectangular region obtained from the determined rectangular region by applying a predetermined rule; and
a transmitting unit coding and transmitting the video signal extracted by said extracting unit, in accordance with said receiving apparatus.

43. A computer-processible recording medium having a program of causing a computer to serve, in a transmitting apparatus according to claim 23, as:
a block dividing unit zone-dividing said even number field or odd number field into a predetermined number of blocks in parallel to the scanning lines of said output unit of said receiving apparatus;
a region determining unit comparing each block of said even number field or odd number field generated by said block dividing unit with each block corresponding to the block within an immediately preceding even number field or odd number field of said predetermined even number field or odd number field, and thereby determining a rectangular region having a different pixel value;
an extracting unit extracting a video signal included in (1) the determined rectangular region or (2) a rectangular region obtained from the determined rectangular region by applying a predetermined rule; and
a transmitting unit of coding the video signal extracted by said extracting unit and then transmitting the signal to said receiving apparatus.
